(19) United States
(12) Patent Application Publication
(10) Pub. No.: US 2025/0205863 A1
(43) Pub. Date: Jun. 26, 2025

(54) TORQUE WRENCH

(71) Applicants: YI-FU CHEN, TAICHUNG CITY (TW); HE-QIAN CHEN, TAICHUNG CITY (TW)

(72) Inventors: YI-FU CHEN, TAICHUNG CITY (TW); HE-QIAN CHEN, TAICHUNG CITY (TW)

(21) Appl. No.: 18/393,720

(22) Filed: Dec. 22, 2023

(51) Int. Cl. B25B 23/142; B25B 23/14

(52) U.S. Cl. CPC B25B 23/1427; B25B 23/141; B25B 23/1425

(57) ABSTRACT

A torque wrench includes a body portion which as a room and a working member is assembled in the room. The working member includes a rod and a working head protruding from the body portion. A torque sensor is connected to the rod of the working member. A release unit is located in the room of the body portion and movably connected to the rod of the working member. A torque setting unit is located in the room to apply a set torque to the release unit. A controller is connected to the torque wrench and electrically connected to the torque sensor and the torque setting unit. When a force applied to the working member exceeds the set torque, the torque setting unit drives the release unit, causing the working member to be free of force.

### FIELD OF THE INVENTION

The present invention relates to a wrench, and more particularly, to a torque wrench wherein the working member is released by a release unit.

### BACKGROUND OF THE INVENTION

Many industries use bolts and nuts as components for assembly. In order to rotate bolts, nuts, etc., wrenches are commonly used for direct driving or socket driving with a wrench adapter. Torque wrenches are essential in industries that require high precision, where tightening and loosening operations must be performed according to specified torque values to avoid damage and ensure operational accuracy.

Common torque wrenches allow users to set a predefined torque, whether they are traditional mechanical or electronic. When the applied force on the torque wrench reaches the set value, it produces an audible reminder for the user. Some electronic torque wrenches may also include visual or vibrational alerts.

However, in noisy work environments such as operating machinery or loud processing sounds (collisions, impacts and friction), users who regularly use torque wrenches in these noisy, polluted environments may easily experience sensory numbness and fatigue. This can lead to negligence in recognizing the reminders and alerts generated by the torque wrench, causing users to stop applying force too late. This delay can result in the applied locking force exceeding the load capacity of the components. Therefore, there is a need for improvements in torque wrench design to address these challenges.

The present invention intends to provide a torque wrench to eliminate the shortcomings mentioned above.

### SUMMARY OF THE INVENTION

The present invention relates to a torque wrench and comprises a body portion having a room defined therein. A working member including a rod is assembled in the room, and a working head is connected to and protrudes from one end of the body. A torque sensor is connected to the rod of the working member. A release unit is located in the room of the body portion and movably connected to the rod of the working member. A torque setting unit is located in the room of the body portion to apply a set torque to the release unit. A controller is connected to the torque wrench and electrically connected to the torque sensor and the torque setting unit. When a force applied to the working member exceeds the set torque, the torque setting unit drives the release unit, causing the working member to be free of force.

Through the above-mentioned structural configuration, the torque wrench is capable of performing preset torque operations. When the torque wrench reaches the preset torque, a release phenomenon occurs, preventing the continuous application of force. This design helps to avoid improper user actions, ensuring that the applied force on the components does not exceed their load capacity. In other words, it ensures that the force on the components complies with specifications.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the torque wrench of the present invention;

FIG. 2 is a schematic diagram of the control block of the torque wrench of the present invention;

FIG. 3 is a partial sectional view of the first embodiment of the torque wrench of the present invention, and

FIG. 4 is a partial sectional view of the second embodiment of the torque wrench of the present invention.

### DETAILED DESCRIPTION OF THE PREFERRED EMBODIMENT

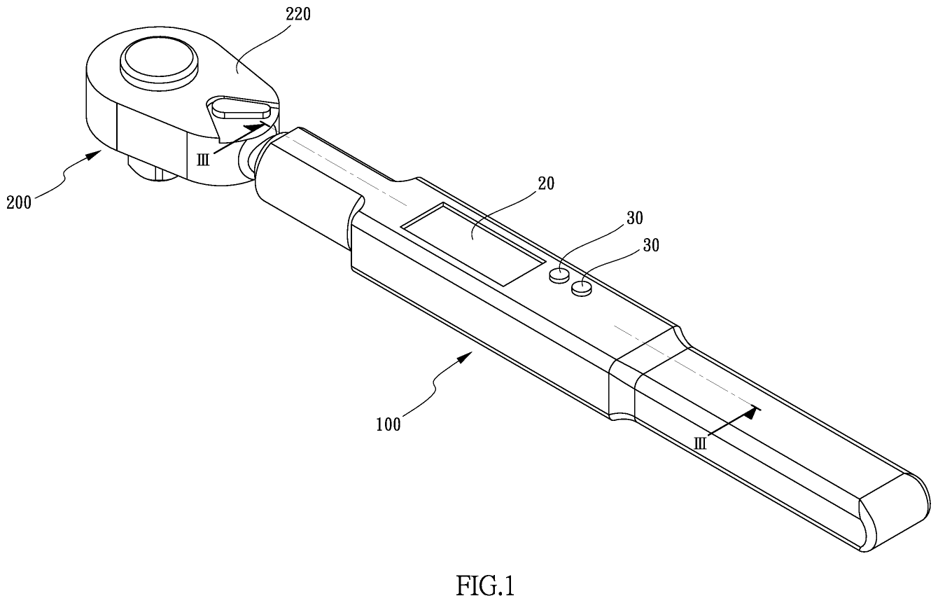

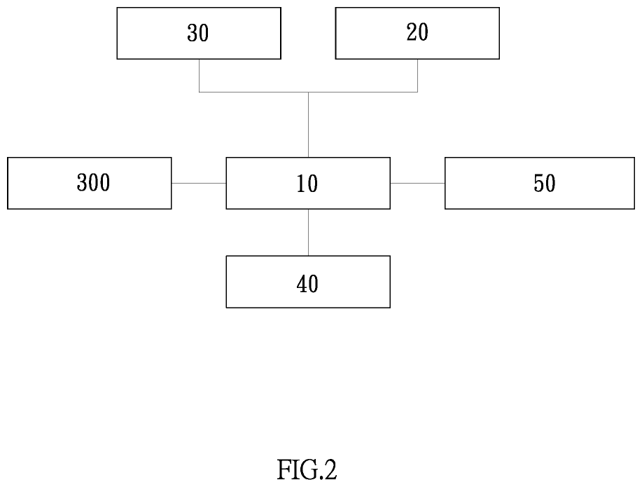

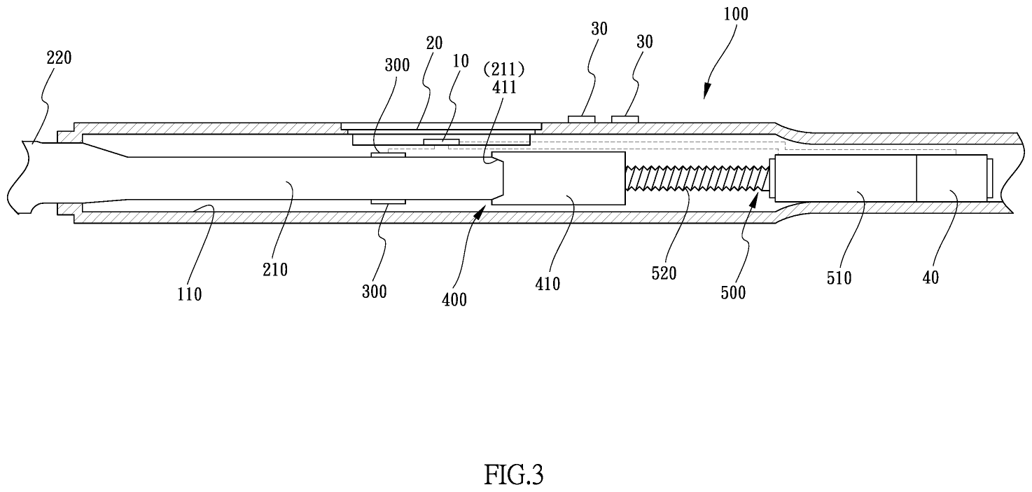

Referring to FIGS. 1-3, the torque wrench of the present invention comprises a body portion 100 having a room 110 defined therein. A working member 200 including a rod 210 is assembled in the room 110, and a working head 220 is connected to and protrudes from one end of the body portion 100. Two torque sensors 300 are connected to two opposite sides of the rod 210 of the working member 200. A release unit 400 is located in the room of the body portion 100 and movably connected to the rod 210 of the working member 200. A torque setting unit 500 is located in the room 110 of the body portion 100 to apply a set torque to the release unit 400. A controller 10 is connected to the torque wrench and electrically connected to the torque sensor 300 and the torque setting unit 500. The controller 10 can be a CPU (Central Processing Unit). When a force applied to the working member 200 exceeds the set torque, the torque setting unit 500 drives the release unit 400, causing the working member 200 to be free of force.

Through the above-mentioned structural configuration, users are provided with a torque wrench for performing preset torque operations. When the torque wrench reaches the preset torque, a release phenomenon occurs, preventing the continuous application of force. This design helps to avoid improper user actions, ensuring that the applied locking force on the components does not exceed their load capacity. In other words, it ensures that the locking force on the components complies with specifications.

Further explanation is provided regarding the detailed features of the torque wrench, the interoperation of various components, and the utility achieved. The torque setting unit 500 includes a motor 510 and a drive shaft 520. The motor 510 (in this embodiment, a brushless DC motor) drives the drive shaft 520 (in this embodiment, a screw is used as the drive shaft), and the drive shaft 520 drives a release seat 410 of the release unit 400. When the motor 510 receives a drive signal from the controller 10, it drives the drive shaft 520 to rotate. The invention adjusts the distance between the release seat 410 and the rod portion 210 by the motor 510 to define the set torque. When the torque wrench is used to reach the set torque, the motor 510 drives the drive shaft 520 synchronously to move the release seat 410 away from the inner rod portion 210, achieving the release state.

In this embodiment, one of two ends of the release seat 410 has a release outer slope 411, and one of two ends of the rod 210 has a release inner slope 211 which is removably engaged with the release outer slope 411 of the release seat 410.

A display screen 20 is installed to the body portion 100 and electrically connected to the controller 10. The display unit 20 is designed to real-time display the torque value detected by the torque sensor 300. It utilizes the strain output signal from the working member 200 to the display screen 20, displaying the force applied to the working member 200 on the display unit 20.

A button 30 is connected to the body portion 100 and electrically connected to the controller 10. The button 30 is used to set the set torque which is displayed on the display screen 20. In this embodiment, the torque sensor 300 is a strain gauge.

In this embodiment, the torque wrench is powered by a battery 40 electrically connected to the controller 10. The battery 40 serves as the power source for the torque sensor 300, the controller 10, the torque setting unit 500, and the display screen 20. In this embodiment, the battery 40 can be installed on the body portion 100, adjacent to one side of the motor 510. The battery 40 can be a rechargeable battery 40 and is actively mounted on the body portion 100 and can be recharged by an external power source.

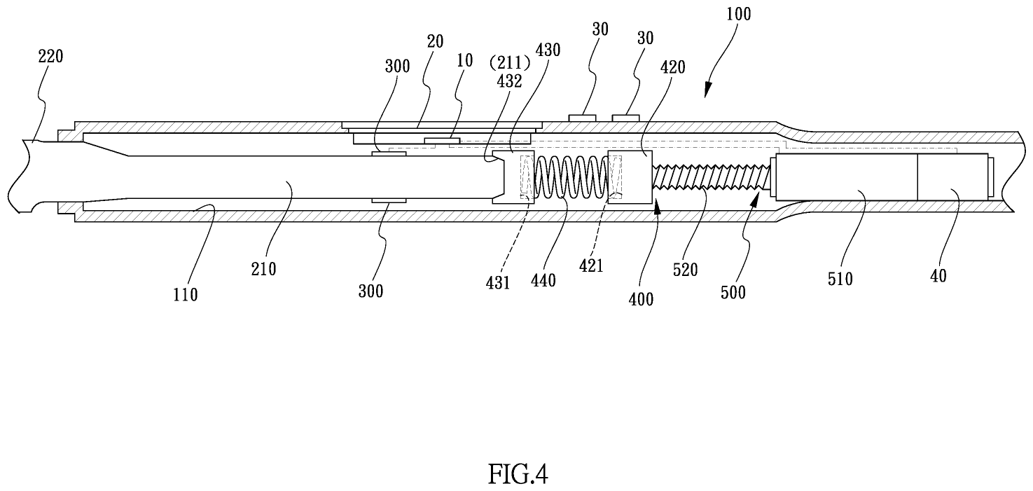

As shown in FIG. 4, the second embodiment of the present invention is disclosed. The differences relative to the first embodiment are that the release unit 400 includes a first release base 420, a second release base 430 and a resilient element 440 between the first and second release bases 420, 430. In this embodiment, the elastic element 440 is a compression spring. By driving the drive shaft 520 by the motor 510, the drive shaft 520 is rotated, and the drive shaft 520 moves the first release base 420, the resilient element 440, and the second release base 430. This arrangement establishes the spacing between the second release base 430 and the rod 210, as well as the compressed state of the resilient element 440, defining the set torque. When the torque wrench is used to reach the set torque, the motor 510 drives the drive shaft 520 and simultaneously moves the first release base 420 away from the rod 210 (changing the pre-loaded compression amount of the resilient element 440), achieving the release state.

In the second embodiment, the first release base 420 has a first recess 421, and the second release base 430 has a second recess 431. Two ends of the elastic element 440 are accommodated in the first and second recesses 421, 431. The resilient element 440 is therefore positioned between the first and second release bases 430, 431 to avoid the resilient element 440 from jumping out from the first and second release bases 430, 431.

In the second embodiment, the second release base 430 has a release outer slope 432, and one of two ends of the rod 210 has a release inner slope 211 which is removably engaged with the release outer slope 432 of the second release base 430.

While we have shown and described the embodiment in accordance with the present invention, it should be clear to those skilled in the art that further embodiments may be made without departing from the scope of the present invention.

What is claimed is:

1. A torque wrench comprising:
a body portion having a room defined therein;
a working member including a rod assembled in the room and a working head connected to and protruding from one end of the body portion;
a torque sensor connected to the rod of the working member;
a release unit located in the room of the body portion and movably connected to the rod of the working member;
a torque setting unit located in the room of the body portion to apply a set torque to the release unit, and
a controller connected to the torque wrench and electrically connected to the torque sensor and the torque setting unit, when a force applied to the working member exceeds the set torque, the torque setting unit drives the release unit, causing the working member to be free of force.

2. The torque wrench as claimed in claim 1, wherein the torque setting unit includes a motor and a drive shaft, the motor drives the drive shaft, the drive shaft drives a release seat of the release unit.

3. The torque wrench as claimed in claim 2, wherein one of two ends of the release seat has a release outer slope, and one of two ends of the rod has a release inner slope which is removably engaged with the release outer slope of the release seat.

4. The torque wrench as claimed in claim 1, wherein the torque setting unit includes a motor and a drive shaft, the release unit includes a first release base, a second release base, and an elastic element located between the first and second release bases.

5. The torque wrench as claimed in claim 4, wherein the first release base has a first recess, the second release base has a second recess, two ends of the elastic element are accommodated in the first and second recesses.

6. The torque wrench as claimed in claim 4, wherein the second release base has a release outer slope, one of two ends of the rod has a release inner slope which is removably engaged with the release outer slope of the second release base.

7. The torque wrench as claimed in claim 4, wherein the elastic element is a compression spring.

8. The torque wrench as claimed in claim 1, further comprising a display screen installed to the body portion and electrically connected to the controller.

9. The torque wrench as claimed in claim 1, further comprising a button connected to the body portion and electrically connected to the controller, the button being used to set the set torque.

10. The torque wrench as claimed in claim 1, wherein the torque sensor is a strain gauge.
